(19) United States
(12) Patent Application Publication
(10) Pub. No.: US 2026/0072982 A1
(43) Pub. Date: Mar. 12, 2026

(54) User-Guided Adaptive Playlisting Using Joint Audio-Text Embeddings

(71) Applicant: Google LLC, Mountain View, CA (US)

(72) Inventors: Aren Jansen, Mountain View, CA (US); Ryan Michael Rifkin, Berkeley, CA (US); Qingqing Huang, Palo Alto, CA (US); Daniel Patrick Whittlesey Ellis, New York, NY (US)

(21) Appl. No.: 19/106,091

(22) PCT Filed: Aug. 25, 2022
(86) PCT No.: PCT/US2022/075444

§ 371 Date: Feb. 24, 2025

(51) Int. Cl. G06F 16/638; G06F 16/635; G06N 3/045; G06N 20/00; G10L 15/26

(52) U.S. Cl. CPC G06F 16/639; G06F 16/635; G06N 3/045; G06N 20/00; G10L 15/26

(57) ABSTRACT

A method includes providing, by an audio playback interface, an initial playlist comprising audio tracks. The method includes receiving a user preference associated with an initial audio track during a listening session, wherein the user preference is indicative of a listening mood of a user and comprises one or more of a user behavior or a natural language input. The method includes generating a representation of the user preference in a joint audio-text embedding space by applying a two-tower model comprising an audio embedding network and a text embedding network. A proximity of two embeddings is indicative of semantic similarity. The method includes training a machine learning model to generate an updated playlist responsive to the listening mood of the user during the listening session. The method includes applying the machine learning model to generate the updated playlist. The method includes substituting the initial playlist with the updated playlist.

### BACKGROUND

Music recommendations can be made based on user preferences, listening history, and so forth. Music playlist generation and music discovery can be generated at the start of each listening session in a user interface for music playback.

### SUMMARY

Music playlist generation and music discovery may be generated at the start of each listening session based on various factors, such as, for example, user listening history, seed song, co-watch data, and musical context. However, these playlists generally do not account for user behavior in a given listening session. Accordingly, there is a need to provide on-the-fly adaptation of music playlists based on the mood of a user in a current listening session. The mood of the user may be inferred by analyzing listen/skip behavior and/or based on natural language input.

In one aspect, a computer-implemented method is provided. The method includes providing, by an interactive audio playback interface, an initial playlist comprising one or more initial audio tracks. The method also includes receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track. The method additionally includes generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity. The method further includes training, based on the representation of the user preference, a machine learning model to generate an updated playlist comprising one or more updated audio tracks, wherein the one or more updated audio tracks are responsive to the listening mood of the user during the listening session. The method also includes applying the trained machine learning model to generate the updated playlist. The method further includes substituting, in the interactive audio playback interface, the initial playlist with the updated playlist.

In another aspect, a computing device is provided. The computing device includes one or more processors and data storage. The data storage has stored thereon computer-executable instructions that, when executed by one or more processors, cause the computing device to carry out functions. The functions include: providing, by an interactive audio playback interface, an initial playlist comprising one or more initial audio tracks; receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track; generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity; training, based on the representation of the user preference, a machine learning model to generate an updated playlist comprising one or more updated audio tracks, wherein the one or more updated audio tracks are responsive to the listening mood of the user during the listening session; applying the trained machine learning model to generate the updated playlist; and substituting, in the interactive audio playback interface, the initial playlist with the updated playlist.

In another aspect, a computer program is provided. The computer program includes instructions that, when executed by a computer, cause the computer to carry out functions. The functions include: providing, by an interactive audio playback interface, an initial playlist comprising one or more initial audio tracks; receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track; generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity; training, based on the representation of the user preference, a machine learning model to generate an updated playlist comprising one or more updated audio tracks, wherein the one or more updated audio tracks are responsive to the listening mood of the user during the listening session; applying the trained machine learning model to generate the updated playlist; and substituting, in the interactive audio playback interface, the initial playlist with the updated playlist.

In another aspect, an article of manufacture is provided. The article of manufacture includes one or more computer readable media having computer-readable instructions stored thereon that, when executed by one or more processors of a computing device, cause the computing device to carry out functions. The functions include: providing, by an interactive audio playback interface, an initial playlist comprising one or more initial audio tracks; receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track; generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity; training, based on the representation of the user preference, a machine learning model to generate an updated playlist comprising one or more updated audio tracks, wherein the one or more updated audio tracks are responsive to the listening mood of the user during the listening session; applying the trained machine learning model to generate the updated playlist; and substituting, in the interactive audio playback interface, the initial playlist with the updated playlist.

In another aspect, a system is provided. The computing device includes means for providing, by an interactive audio playback interface, an initial playlist comprising one or more initial audio tracks; means for receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track; means for generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity; means for training, based on the representation of the user preference, a machine learning model to generate an updated playlist comprising one or more updated audio tracks, wherein the one or more updated audio tracks are responsive to the listening mood of the user during the listening session; means for applying the trained machine learning model to generate the updated playlist; and means for substituting, in the interactive audio playback interface, the initial playlist with the updated playlist.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 is a diagram illustrating an example audio-text embedding framework, in accordance with example embodiments.

FIG. 2 is a diagram illustrating an example adaptive playlist system, in accordance with example embodiments.

FIG. 3 is a diagram illustrating training and inference phases of a machine learning model, in accordance with example embodiments.

FIG. 4 depicts a distributed computing architecture, in accordance with example embodiments.

FIG. 5 is a block diagram of a computing device, in accordance with example embodiments.

FIG. 6 depicts a network of computing clusters arranged as a cloud-based server system, in accordance with example embodiments.

FIG. 7 is a flowchart of a method, in accordance with example embodiments.

### DETAILED DESCRIPTION

Music tagging and content-based retrieval systems have traditionally been constructed using pre-defined ontologies covering a rigid set of music attributes or text queries. Classifiers are generally trained to label examples with predefined and fixed class inventories, which are often manually specified as a structured ontology indicating inter-class relationships. Although visual domains have benefited from an availability of large amounts of captioned images available across the web, in the general environmental audio domain, such large-scale audio-caption pairs are less readily available and related efforts have relied on small captioned datasets. Critically, these small captioned datasets do not span the diversity of sound-descriptive language and their success in the more difficult zero-shot setting has been lacking. While general environmental audio consists of background sounds that are unlikely to elicit unprompted description, music audio is often a central focus. Consequently, text associated with music videos is much more likely to relate to the underlying musical concepts (e.g., genres, artists, moods, structure). Accordingly, a flexible language interface is described whereby a musical concept can be linked to related music audio.

In unsupervised and self-supervised pre-training, both discriminative and generative model approaches have been used. For example, in discriminative training, existing models have been designed to learn representations that assign higher similarity to audio segments extracted from the same recording compared to segments from different recordings. Also, for example, intermediate embedding of a generative model has been shown to provide an audio representation for downstream classification. Various forms of weak supervision, such as user preference statistics and visual cues, have also been examined.

Similar to the use of contrastive learning to align image features and free-form natural language using large-scale data, tri-modal architectures are available where an audio tower is used for the image-text model and contrastive learning is used to enforce the cross-modal alignment. In the audio domain, contrastive learning has been used to align the latent representation of audio and associated tags. The tags can be obtained from a fixed vocabulary of size 1K from the dataset, Freesound, and the input to the text encoder can be the multi-hot encoded tags. A pretrained, non-contextual word embedding (Word2Vec) model may be used to support a generalization to new terms beyond the 1K tags. Contrastive learning has also been explored for zero-shot audio classification, using the AudioSet and ESC-50 dataset. However, these models do not support generalization to free-form natural language.

Some existing methods use text label classes to ground the semantics in music with a multi-label classification task. For example, a large vocabulary of n-grams (e.g., approximately 100K) may be mined from noisy natural language text associated with music videos. Then, a cross entropy loss may be employed to train the music audio encoder, where the softmax layer weights serve as text label embeddings that can be aligned with audio features by construction. Various training tasks (e.g., classification, regression, metric learning) to align free-form text and music audio, relying on pre-existing emotion labels to connect the modalities, have also been explored. Also, for example, a large number of audio-caption pairs (e.g., approximately 250K) may be mined from a private production music library and used to train a multimodal Transformer with early fusion of the two modalities with a triplet loss. However, the choice of early fusion, as accomplished with cross-attention layers, restricts the utility of the resulting embeddings to transfer learning applications.

Accordingly, there is a lack of acoustic models that link music audio directly to unconstrained natural language music descriptions. Content-based music information retrieval can be greatly enhanced by linking the rich semantics expressible to free-form text with both broad and fine-grained musical properties. As described herein, a two-tower parallel encoder approach results in a joint embedding space that provides a natural language interface to arbitrary music audio. Such an architecture facilitates downstream opportunities for cross-modal retrieval, zero-shot tagging, and language understanding. Also, for example, late fusion of the two modalities with a contrastive loss enables effective and efficient use of in-batch negative samples to speed up the training, compared to a triplet loss with a single random negative.

Also as described herein, less restrictive natural language interfaces may be developed to access the categorical information underlying raw content signals. A cross-modal supervision model using an abundance of text annotations that are weakly associated with the music audio is described. The model depends on large-scale training resources and flexible neural network architectures that can be configured to model the complex, non-monotonic relationship between language and other modalities. As described herein, a two-tower, joint audio-text embedding model can be trained using music recordings (e.g., 44 million music recordings corresponding to approximately 370K hours), and weakly-associated, free-form text annotations. A large number of text label classes may be generated to ground the semantics in music with a multi-label classification task. This may be achieved by extracting textual annotations from metadata, comments, and playlist data may be collected and mapped to a training set (e.g., a set of over 44 million internet music videos). As with certain image-text model training, the text data is representative of musical content in a fraction of cases. Therefore, in some embodiments, text pre-filtering may be applied using a text classifier separately trained to identify music descriptions.

Such a large-scale dataset may be used to train a semantically-structured music audio embedding model equipped with a natural language interface. The model employs a two-tower parallel encoder architecture, using a contrastive loss objective that elicits a shared embedding space between music audio and text. For the audio tower, a state-of-the-art ResNet-50 and transformer-based audio modeling architectures may be evaluated, each initialized using different pre-training strategies. A bidirectional encoder transformer (BERT) neural language model architecture may be used for the text tower that may be warm-started with a publicly available pretrained checkpoint.

These evaluations indicate a state-of-the-art performance of the model in transfer learning for various music information retrieval tasks. The model also enables a range of functionalities in cross-modal text-to-music retrieval, zero-shot music tagging, and music-domain language understanding.

Accordingly, a shared embedding space is described for music audio and free-form natural language text, in which proximity is predictive of shared semantics both within and across modalities. To accomplish this, cross-modal contrastive learning may be used with a simple two-tower architecture. A large-scale training dataset of (audio, text) pairs is mined and used for training the model. This may be combined with a text pre-filtering mechanism to boost supervision quality for the contrastive objective.

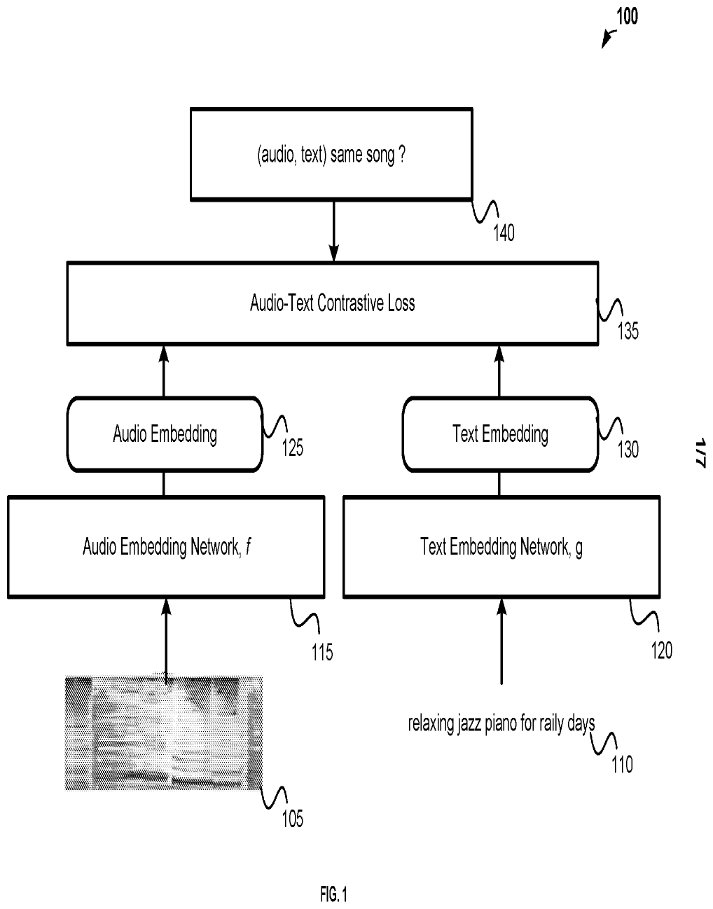

FIG. 1 is a diagram illustrating an example audio-text embedding framework 100, in accordance with example embodiments. FIG. 1 illustrates a high-level schematic of the machine learning framework. Some embodiments involve generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity. For example, each adaptive playlisting model consists of two separate embedding networks for the audio and text input modalities. In some embodiments, these networks may each terminate in [symbol] -normalized embedding spaces with the same dimensionality d. In some embodiments, the networks may not share weights. The audio embedding network 115, f: [symbol] → [symbol] , takes as input log mel spectrogram context windows 105 with F mel channels and T frames. The text embedding network 120, g: [symbol] → [symbol] takes as input a null-padded text token sequence 110 of length n over a token vocabulary [symbol] .

Given a set of music recordings and the associated text elements for each recording, a cross-modal training dataset of (audio, text) pairs may be generated. For each recording, an F-channel log mel spectrogram may be determined and a collection of T-frame context windows may be extracted. Each associated text element may be null-padded or truncated to a fixed length n. Accordingly, each mini-batch [symbol] may consist of a set of B target audio-text pairs of the form

$${\{ {x}^{( i )} , {t}^{( i )} \}}_{i = 1}^{B} .$$

In some embodiments, each target pair may be sampled by first selecting a random recording and sample a random spectrogram context window x⁽ⁱ⁾∈ [symbol] from it. Next, an associated text element t⁽ⁱ⁾∈ [symbol] may be randomly selected. Based on this sampling scheme, multiple epochs may be utilized to cover an entirety of the training audio and all the associated text.

In some embodiments, for each mini-batch of music video soundtracks and the set of text annotations associated at video level, a mini-batch of (audio, text) pairs may be constructed by extracting a random 10-second window from each soundtrack, and choosing a random associated text annotation from the desired source. In some embodiments, the remainder of the soundtrack may not be used.

Audio embedding network 115 may generate audio embedding 125, and text embedding network 130 may generate text embedding 130. In some embodiments, multiple text annotations for each example may be concatenated. Some embodiments involve contrastive training of the audio embedding network and the text embedding network based on audio-text contrastive loss. For example, training of audio embedding network 125 and text embedding network 130 may include training to minimize audio-text contrastive loss 135 (e.g., a batch-wise contrastive multiview coding loss function). In such embodiments, the audio-text contrastive loss is a cross-modal extension of an Info Noise-Contrastive Estimation (InfoNCE) loss and a Normalized Temperature-scaled Cross Entropy (NT-Xent) loss. For example, audio-text contrastive loss 135 may be a cross-modal extension of the InfoNCE and the NT-Xent losses. For each batch [symbol] , audio-text contrastive loss 135, [symbol] ( [symbol] ), takes the form:

$$ℒ ( ℬ ) = {\sum }_{i = 1}^{B} - log [ \frac{h [ f ( {x}^{( i )} ) , g ( {t}^{( i )} ) ]}{{\sum }_{j \neq i} h [ f ( {x}^{( i )} ) , g ( {t}^{( j )} ) ] + h [ f ( {x}^{( j )} ) , g ( {t}^{( i )} ) ]} ] \qquad ( Eqn . 1 )$$

where h is a critic function given by h[a, b]=exp(a^{T}b/τ) for a, b∈ [symbol] , and τ∈(0,1] is a trainable temperature hyperparameter. For the [symbol] -normalized embedding model outputs, the inner product may be cosine similarity. The goal of the critic function, h, is to produce a large positive value for target audio-text pairs 140, and a small value close to zero for all non-target audio-text pairs 140 constructed within the batch.

### Audio Embedding Network

One or more audio architectures may be utilized for audio embedding network 115, f. In some embodiments, the audio embedding network includes one or more of (i) modified Resnet-50 architecture, where a stride of 2 in a first convolutional layer is removed, or (ii) an Audio Spectrogram Transformer (AST). For example, the Resnet-50 architecture may be suitably modified, where the stride of 2 in the first convolutional layer may be removed, and the architecture may be applied to log mel spectrograms (e.g., F=64 mel channels, 25 ms Hanning window, 10 ms step size) treated as grayscale images. In order to allow the modeling of longer-term musical structure, 10-second windows (randomly selected from each training clip), in the form of (F=64)×(T=400) spectrogram patches may be used for training.

In some embodiments, SpecAugment may be applied during training to each spectrogram 105 prior to providing it to the embedding network. In some embodiments, a final mean pooling operation may be applied across time and mel channels followed by a linear fully connected layer with d=128 units, whose output is [symbol] -normalized. All layers, except the final linear transform layer, may be pre-trained via logistic regression on AudioSet (e.g., including all 527 classes). In some embodiments, the final classifier layer may be removed prior to fine-tuning for the playlist generation task.

Another architecture that may be used is an Audio Spectrogram Transformer (AST), which is a port of the Vision Transformer (ViT) base architecture, and is generally used in the audio event classification space. In some embodiments, AST may include a stack of 12 Transformer blocks (e.g., hidden dimension 768, 12 self-attention heads) that may be applied to a sequence of “tokens” corresponding to a flattened set of linear-transformed 16×16 (e.g., stride 10 along both axes) time-frequency patches that may be extracted from the (F=128)×(T=400) log mel spectrogram context windows. As before, SpecAugment may be applied during training. Similar to the Transformer-based language models, trainable positional encodings may be added to the sequence of patch tokens, and a [CLS] token may be prepended to the sequence as a summary of the contextual patch embeddings. In some embodiments, a linear fully-connected layer with d=128 units and [symbol] -normalization may be applied to the final 768-dimensional encoding at the [CLS] token position, and this may form an output of audio embedding network 115, f. The training may be warm-started for all but the final linear transform layer, such as, by using a public AST checkpoint.

In some embodiments, a large pre-training dataset of over 50M random internet video soundtracks may be used, where a vocabulary of 10K video-level metadata tags (mostly not music related) may be predicted, and the final classifier layer may be removed prior to the fine-tuning for the joint embedding.

### Text Embedding Network

In some embodiments, the text embedding network includes a Bidirectional Encoder Transformer (BERT) with base-uncased architecture. For example, a BERT with base-uncased architecture may be used for text embedding model 130. Generally, BERT includes a stack of 12 transformer blocks (e.g., hidden dimension of 768 and 12 self-attention heads). A BERT wordpiece tokenizer may be applied to convert a text input string into a sequence of tokens n=512. The output of text embedding network 120 is defined to be the [CLS] token embedding 130, linearly transformed to the shared audio-text embedding space (e.g., of dimension d=128) and subsequently [symbol] -normalized. Text embedding network 120 may be warm-started using a publicly available checkpoint.

Audio embedding 125 and text embedding 130 may be jointly embedded in a joint embedding space where proximity is semantically driven. For example, for words that have a given meaning, the nearby music in the embedding space will be related to the meaning that moves words.

### Training Dataset

A collection of 50 million internet music videos may be used as a starting point for assembling a large-scale collection of (audio, text) pairs needed to train the playlist generation embedding models. From the soundtrack of each video, a 30-second clip may be extracted starting at the 30 second mark. Subsequently, a pre-existing music audio detector may be applied, and clips that are less than half music content may be removed. After this filtering, there may be approximately 44 million 30-second clips, which amounts to nearly 370K hours of audio.

One or more sources of noisy text data may be used for each music video, including, for example: (i) short-form (SF) text including video titles and tags; (ii) long-form (LF) text including video descriptions and comments; and (iii) titles of 171 million playlists (PL) that are linked to the internet music videos in our dataset. Generally, there is no guarantee that these text sources may be referring to the musical properties of the soundtrack. In particular, comments data may include a significant amount of noise, and may be subjective, or less directly related to the music content. Table 1 below illustrates examples that may be music-related to provide a flavor of each type of text annotation.

TABLE 1

| Type | Examples |
|---|---|
| Short-form (SF) | tags like genre, mood, instrument, artist name, |
| | song title, album name |
| Long-form (LF) | ‘Hip-hop features rap with an electronic backing.’ |
| | ‘The melody is so nostalgic and unforgettable.’ |
| Playlist (PL) | ‘Feel-good mandopop indie’, ‘Latin workout’ |
| | ‘Salsa for broken hearts’, ‘Piano for study’ |

In some embodiments, due to the highly noisy text, training playlist generation may be performed with the SF and LF text data filtered to a cleaner set of music-descriptive annotations (PL is used unfiltered). Accordingly, a pre-trained BERT model may be fine-tuned with a binary classification task on a small curated set of 700 sentences. The sentences in the curated set may be manually labeled to be music-descriptive or not. This text classifier may be applied to filter the sentences in the LF annotations. To filter the playlist titles, a perplexity threshold using a language model that has been fine-tuned on a curated set of 7000 high quality playlist titles may be applied. In some embodiments, a set of rule-based filtering heuristics may be independently applied to clean up the SF annotations.

Table 2 below shows the size and coverage of each of these text sources, both before and after filtering. Tokens counts (in billions) are across all 44M videos. APV represents an average number of text annotations (i.e. separate free-form strings) per video, including those with no annotations. In some embodiments, playlist titles and/or filtered long-form annotations may only be available for a minority of recordings in the dataset (18M and 6.8M out of the total 44M, respectively).

TABLE 2

| | |
|---|---|
| Pre-filter | Post-filter |

| Type | Tokens (B) | APV | Tokens (B) | APV |
|---|---|---|---|---|
| Short-form | 31.2 | 42.9 | 5.4 | 29.6 |
| Long-form | 30.7 | 70.7 | 0.2 | 0.4 |
| Playlists | 2.5 | 24.3 | — | — |

In some embodiments, AudioSet may be converted into a set of audio-text pairs, denoted as ASET. In particular, all examples for all 527 classes may be included, using each label string attached to an example as an associated text annotation. This may result in a set of approximately 2 million 10-second clips for training, each with 1.8 label annotations on average.

Generally, there may be scale imbalances between the four different data sources, due to differences in respective linguistic richness and quality. Accordingly, in some embodiments, each mini-batch may be constructed with a prescribed set of proportions that can be chosen without optimization: 2:2:1:1 for SF:LF:PL:ASET. This means that despite a small scale, the filtered LF annotations may still comprise ⅓ of each mini-batch.

For each mini-batch of music video soundtracks and the set of text annotations associated at video level, a mini-batch of (audio, text) pairs may be constructed by extracting a random 10-second window from each soundtrack (discarding the remainder) and choosing a random associated text annotation from the desired source. Such a sampling scheme may be performed by using multiple epochs to cover the training audio and the associated text.

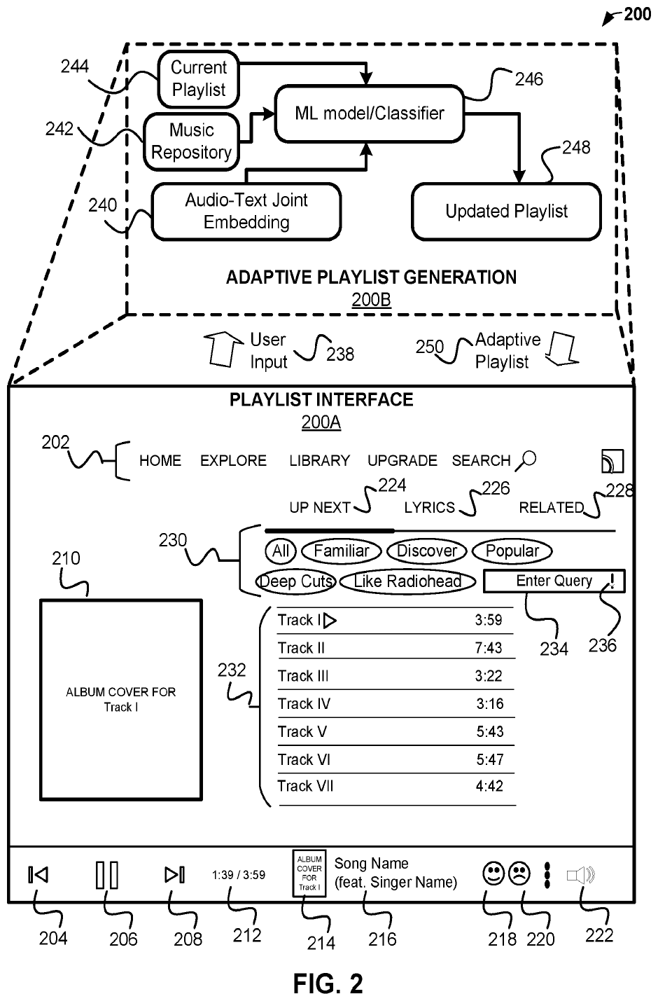

FIG. 2 is a diagram illustrating an example adaptive playlist system 200, in accordance with example embodiments. Some embodiments involve providing, by an interactive audio playback interface, an initial playlist comprising one or more initial audio tracks. Playlist interface 200A may be a user interface for music playback. For example, a plurality of top menus 202 may include menu options for “Home,” “Explore,” “Library,” “Upgrade,” and “Search.” Playlist interface 200A may include playback options such as rewind button 204, play/pause button 206, forward button 208. An album cover 210 may be displayed for a current audio track being played. An elapsed time indicator 212 may indicate how much of the track has been played. Also, for example, a thumbnail image 214 for album cover 210 may be provided, along with features 216 associated with the album (e.g., singer, song, genre, year of release, and so forth). A like icon 218 may enable a user to indicate that they like the current track, and an unlike icon 220 may enable a user to indicate that they do not like the current track. A volume adjustment control 222 may also be provided to adjust a level of output for the audio.

For a current listening session, additional submenus may be provided, such as “Up Next” 224, “Lyrics” 226, and “Related” 228. Upon selection of “Up Next” 224, one or more recommended keywords 230 may be provided as selectable icons, such as, for example, “All,” “Familiar,” “Discover,” “Popular,” “Deep Cuts,” “Like Radiohead,” and so forth. A user may select a selectable icon to indicate a preference, and the system may adapt the playlist to the selected keyword. A current playlist 232 is displayed listing tracks selected for the user. For example, the first track, “Track 1” may have an associated “play” indicator displayed, indicating that the track is being played.

Generally speaking, each user may be represented as a bag of fine-grained musical interest prototypes in some abstract space, as a highly specialized intersection of genre and mood. Over extended time spans, each user may span a broad sampling of these interest prototypes, but in each listening session a relatively small number of the interest prototypes may be targeted for an optimal listening experience. A pre-generated playlist may not know a priori which interest prototypes are preferable to the user in any given listening session. Accordingly, user behavior in a given session may provide a near accurate indication of the interests of the user during that session.

One way to characterize target prototypes is by using a binary classifier trained on top of a general-purpose content representation that characterizes mood and genre and thus may act as a proxy for user interest. This binary classifier may be a means to identify which interest prototypes are active for the user in the given session. For example, an interest space may be generated that has a natural cluster structure with centroids defining the interest prototypes. A user in each session is a bag of such interest-centroids. The content embedding space may serve as a proxy for the interest space, and the classifier can be trained to learn which collection of these prototypes are activated by operating in the embedding space. In some embodiments, a nearest neighbor model may be used as ML model 246. However, the geometry of the embedding space may impose additional limitations that may render the nearest neighbor model somewhat inefficient. In some embodiments, a general model family (e.g. a multilayer perceptron (MLP)) may be used, that can accommodate more complex regions in the embedding space (i.e. not easily modeled in terms of [symbol] distance to training examples) may be used.

In each listening session, a user may provide one or more contemporaneous inputs such as: (i) a listen/skip behavior for that session, or (ii) a set of user-provided natural-language inputs describing their current interests. Generally, the adaptive playlisting model may be built using the audio, and/or co-watch embeddings. Joint embedding with text provides additional data that can capture user preferences. As used herein, “joint” means that a single classifier would handle both types of embeddings (e.g., the two-tower constructions described herein). At the beginning of a listening session, an initial candidate playlist or library of relevant Tracks may be initialized. For example, the initial playlist may be obtained by applying a seeded generation procedure (e.g., as is currently produced by YOUTUBE™ Music and YOUTUBE™ Mix).

When a user is listening to audio tracks in a session, existing recommendation systems generally represent the user as an average of long-term listening behavior (e.g., picking a track from a user distribution that captures long-term behavior). However, such a representation generally fails to be adaptive to a mood of the user in a current session. Long term behavior of a user may be represented as a collection of modes, and at a given point in time, tracks may be drawn from one of these modes, and not drawn from the entire user distribution. Accordingly, user behavior during a current session can be indicative of one or more modes from which a track may be selected for the current session. Additionally, when the user behavior during the current session is represented using a joint audio-text embedding, it may be easier for a model to identify the playlist.

For example, the joint embedding space is relatively compact, so relatively simple classifiers may be built in the joint embedding space. Also, for example, the joint embedding space is structured in a way where simple models can be musically meaningful. Thus, the recommendations have less reliance on metadata associated with a track, or preferred genres, artists, and so forth. Musical features such as tempo, instruments, genre, beat, melody, rhythm, and so forth are characterized in the joint embedding space. Accordingly, hyperplanes may be constructed that can separate points in the embedding space in a subtle manner, as opposed to a coarse separation of likes and dislikes.

For example, a rock band may have been around for a long time and the band may have dabbled in different genres over the years, or their style may have changed, or a singer or a guitarist or a drummer may have left or joined the band. Accordingly, a single band may have several different types of music, and a user may not be interested in only certain types of music produced by the rock band. A classifier based on artists, genre, and so forth may not be able to distinguish between the different aspects of such a rock band's musical output. Instead, a finer similarity based approach may provide meaningful distinctions. The joint embedding space is structured so that semantically similar music and words are co-embedded proximate to each other.

Generally, the user may provide various signals indicating a listening mood. The term “listening mood” may refer to a musical preference of a user during a session. For example, even though a user may generally listen to jazz or rock music, the user may be more interested in western flute instrumentals in a given listening session. Also, for example, various factors such as weather, a time of day, a season, a social gathering, a holiday, a special occasion, a road trip, and so forth, may influence the listening mood of the user during any particular listening session. Accordingly, the user may choose to listen to an audio track (e.g., Track I) in its entirety, and/or listen to a substantial portion of the audio track. Such a signal may be labeled as a positive example indicative of the listening mood. For example, if Track I is a flute concerto by Mozart, then adaptive playlist generation system 200B may infer the listening mood of the user as including western flute instrumentals. In some embodiments, a known user preference for Mozart and Beethoven (e.g., based on music repository 242) may be used by adaptive playlist generation system 200B to infer the listening mood of the user as including western flute instrumentals by Mozart and Beethoven.

Also, for example, the user may choose to skip one or more audio tracks in playlist 232. For example, after listening to Track I, the user may choose to skip Tracks II and III (or listen to a small portion of an audio track). Such a signal may be labeled as a negative example indicative of the listening mood. For example, Track I may be a flute concerto by Mozart, and Tracks II and III may be concertos for flute and piano. Based on a positive signal related to Track I and a negative signal related to Tracks II and III, adaptive playlist generation system 200B may infer the listening mood of the user as including flute instrumentals, but not flute and piano instrumentals. As another example. Track I may be a flute concerto by Mozart, Track II may be a concerto for flute and piano, and Track III may be a track for a flute with a string quartet. The user may listen to Tracks I and II, and skip Track II. Accordingly, a positive signal may be associated with Tracks I and III, and a negative signal may be associated with Track II. Based on such signals, adaptive playlist generation system 200B may infer the listening mood of the user as including flute instrumentals, flute and string combinations, but not flute and piano combinations.

The term “initial audio track” may refer to any track in playlist 232. In some embodiments, the initial audio track may be the audio track at the top of playlist 232, and/or the currently playing audio track. In some embodiments, the initial audio track may be a skipped audio track, or an audio track that the user listened to for less than a threshold amount of time (e.g., less than 5% of the audio track). Also, as described herein, playlist 232 may be updated with each track listened to, skipped, and/or a natural language input. Accordingly, initial playlist 232 would then be considered to represent the updated playlist for the next iteration of the user preference based playlist generation process.

Some embodiments involve training, based on the representation of the user preference, a machine learning model to generate an updated playlist comprising one or more updated audio tracks, wherein the one or more updated audio tracks are responsive to the listening mood of the user during the listening session. For example, a binary classifier may be repeatedly trained at each step (i.e. skip/listened track, keyword guidance) of the listening session (e.g., by using the whole session history at that point). The goal of the binary classifier is to produce high scores for desirable tracks and low scores otherwise. In some embodiments, the classifier can be applied to reprioritize the remaining tracks of the pre-generated playlist or be used to mine new playlist candidates from a larger set.

For example, at time, T=0, all tracks in this initial playlist offering 232 may be considered to be unlabeled with respect to the user's interests for the session. It may be assumed each track in the playlist is either skipped or listened to, as determined by a suitable heuristic (e.g. at least 50% of the track is played back to qualify as listened to). Tracks that are listened to may be associated with a positive label, while tracks that are skipped may be associated with a negative label. Moreover, natural language tags describing user interest may be deemed to be additional positive examples.

Some embodiments involve receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track, user preference (e.g., user input 238) may generally refer to any user input that indicates a preference for the music in the current playlist. For example, a track may be skipped, and this may be a negative example. Also, for example, a track may be played for less than a threshold amount of time, thereby indicating that the track was effectively skipped. This user behavior may also be labeled as a negative example. However, when the user listens to a track, this may be labeled as a positive example. Also, for example, any text input by the user may be labeled as a positive example. Labels may also be associated with user preference with like button 218, or dislike button 220. In some embodiments, a user may reorder playlist 232, and the re-ordering may be used to determine weights in the rank scoring to be output by ML model 246.

User input 238 may be received by adaptive playlist generation 200B. Audio-text joint embedding 240 may be generated. For example, given a joint audio-text embedding model, both the track audio and the natural language guidance may be embedded into compatible spaces. Therefore, at each point, T, in the listening session, a collection of labeled examples of the form Z_{T}={(Xᵢ, Yᵢ, Aᵢ)|i=1, . . . , T} may be generated, where each Xᵢ∈ [symbol] is the embedding (e.g., audio for skip/listen inputs, or text for natural language inputs) for the i-th user input, Yᵢ∈{0, 1} is a label that may be set to 1 for all natural language inputs and majority-played tracks, and 0 for early-skipped tracks, and Aᵢ ∈{0, i} is 1 if the i-th example is an audio embedding and 0 if the i-th example is a text embedding. For example, user input 238 may be a combination of a skip-track audio embedding, a listen-track audio embedding, or a text embedding for a user entered keyterm. In some embodiments, the user behavior with the initial audio track includes an indication of whether the user listened to, or skipped, the initial audio track. Such embodiments involve assigning a negative label to the initial audio track if it is skipped, or assigning a positive label to the initial audio track if it is listened to. For example, each embedding may be associated with a negative, positive, and positive label, respectively. In some embodiments, the user entered keyterm may be allocated a higher relative weight.

In some embodiments, a query entry box 234 may be provided to enable user preference in the form of text input by the user. In some embodiments, the text input is a natural language input. However, user input may also be a voice command issued by the user. In some embodiments, the text input is a transcription of a voice input by the user. For example, the user may be talking to a device, and perhaps in the middle of a playlist listening experience, the user may say, “make it more like more rock and roll,” or “make it higher energy.” Such a voice command may be transcribed into text and used as a user entered keyterm. The keyterm is input to a text embedding network (e.g., text embedding network 120 of FIG. 1), which generates a text embedding (e.g., text embedding 130) in a joint embedding space. A user may enter a text string in query entry box 234 to indicate a preference. In some embodiments, a microphone 236 may be provided to enable the user to input voice instructions into query entry box 234. In some embodiments, a user's voice is transcribed and displayed as text in query entry box 234. Some embodiments involve assigning a positive label to the text input.

In some embodiments, retraining of ML model 246 may be performed from scratch for each session. Generally speaking, the original playlist offering is a good neutral playlist that has already been specialized to the user. So ML model 246 has to implicitly infer the user's mood for a current session relative to a broader historical profile. Accordingly, after a small number of examples, large portions of the playlist may be removed from consideration (e.g. a broader historical profile for the user may indicate a preference for jazz or classical, but the mood for the current session is not jazz or classical).

In some embodiments, a large number of popular songs (e.g., 150K) that are otherwise random genres, may be used as the original playlist (e.g., from music repository 242). Such a choice can allow exploring of a space outside a usual comfort zone of the user (e.g., the main value of audio features over co-watch). Generally, not having an adequate connection to a background taste of a user may require a fair amount of skip/listen activity in a current session to reduce noise in the recommendation quality. Accordingly, in some embodiments, a large collection of songs may be used, and the listening history of the user may be used as a prior for the model, and mood related examples may then be efficiently generated with some labeled examples (e.g., skip/listen activity in the current session).

In some embodiments, the embedding space may be 128 dimensional, and ML model 246 may be a linear classifier that may be trained after each skip/listen, and inference may be performed on the rest of the playlist, followed by a sort operation. The amount of compute needed for these operations is generally very small, and may be performed on the device (e.g., a smartphone) with little to no additional latency.

In some embodiments, the machine learning model may be a linear classifier trained upon receipt of the user preference. In such embodiments, the training of the linear classifier involves training the classifier with loss weighting. For example, adaptive playlist generation 200B may involve using Z_{T} to train a classifier 246, g_{T}: [symbol] → [symbol] , with loss weighting. Although a classifier is used for illustrative purposes, a more general ML model 246 may be used, based on the current session. In some embodiments, the loss weighting may include per-example loss weights that depend on each Aᵢ. In some embodiments, the user behavior with the initial audio track is associated with a relatively smaller loss weight than the text input. For example, a skip/listen action by the user may be associated with less weight than a natural language input from the user. In some embodiments, an earlier user preference is associated with a relatively smaller loss weight than a more recent user preference. For example, the loss weighting may include per-example loss weights that depend on a position in history. For example, a more recent action may be associated with more weight than an earlier action. In some embodiments, a time threshold may be used to identify a recent action.

Some embodiments involve applying the trained machine learning model to generate the updated playlist. In some embodiments, the applying of the trained machine learning model comprises applying the trained machine learning model to one or more of remaining initial audio tracks in the initial playlist, or a music library. For example, upon training, the classifier g_{T} 246 may be applied to the remaining tracks in current playlist 244, and/or a broader library such as music repository 242. In some embodiments, the music library includes a collection of audio tracks associated with a listening history of the user. For example, music repository 242 may include tracks that the user has previously listened to, a personal library associated with the user, a large co-watch cluster, and so forth.

In some embodiments, the applying of the trained machine learning model involves sorting the updated playlist based on relevance of an audio track to the listening mood of the user during the listening session. For example, classifier 246 may sort an updated playlist by a descending order of scores, where a higher score is indicative of a higher relevance to a mood of the user in the current session. For example, the collection of N tracks in the joint embedding space may be collectively represented as a N×d matrix S, where d is the dimension of the joint embedding space. A d-dimensional vector w of weights may be used to multiply with S, such as S.w, and this provides a sorting of the collection of tracks.

Some embodiments involve substituting, in the interactive audio playback interface, the initial playlist with the updated playlist. A next track may be presented to the user from the ordered updated playlist, and user preference (e.g., skip/listen behavior of the user and/or a natural language input by the user) may be identified. Accordingly, Z_{T+1}=Z_{T}∪{(Xᵢ₊₁,Yᵢ₊₁,Aᵢ₊₁)} may be determined. Again, as described, the process may be repeated by training classifier g_{T} using Z_{T+1} in place of Z_{T}.

As the process proceeds iteratively, the term “initial playlist” as used herein may refer to a first playlist (e.g., seed playlist) at the beginning of a session, and may also refer to a current playlist during the listening session. For example, an initial playlist at time T may be updated with an updated playlist, and the updated playlist may be the initial playlist at time T+1. Also, for example, the term “initial audio track” may generally refer to an audio track in the initial playlist at time T, or an audio track in the updated playlist, which is the initial playlist at time T+1. In some embodiments, the initial audio track may be a currently playing audio track.

In some embodiments, the machine learning model may be a nearest neighbor retrieval model. Such embodiments also involve applying the nearest neighbor retrieval model in the joint audio-text embedding space to generate the updated playlist comprising one or more audio tracks proximate to the representation of the user preference. As an example, users may provide a natural language input “chill folk music” or “high energy rock music” in query entry box 234. At the initial stages of the current session, there may not be enough labeled examples to train classifier 246. Accordingly, the input text may be embedded in the audio-text joint embedding 240, and one or more audio tracks may be identified based on a nearest neighbor search in the audio-text joint embedding 240. As these tracks are played, additional input may be received from the user, and this may then enable training of the classifier 246. Accordingly, the initial text input may be taken as a positive example, tracks based on a nearest neighbor search may be played, additional positive and negative examples may be received, the classifier 246 may be trained based on the additional examples, and an adaptive playlist 250 may be output based on scores generated by the classifier 246. Accordingly, a smooth transition may occur from a nearest neighbor model based playlist to a classifier 246 based playlist, after a threshold number of positive and negative examples are generated. As the listening session progresses, the number of labeled examples N may increase, which may improve the quality of the classifier 246 and, after reprioritization, also improve inferring the listening mood of the user.

In some embodiments, a user may be in a session for a long time and there may be a plurality of positive and negative examples provided by the user during the session. At some point, the user may want to change from rock music to jazz music, and may provide a voice command, “switch to jazz.” Accordingly, the classifier 246 may be iteratively trained as described to slowly move from rock music to jazz music. However, given the large number of labeled examples related to rock music in the current session, it is likely that classifier 246 may continue to provide some tracks for rock music, until a sufficient number of labeled examples are received related to jazz music. Another strategy may be to assign a larger weight to the text input indicating a change in genre from rock to jazz. Based on a substantially larger weight for the positive example related to the text input, classifier 246 may be trained to adapt more quickly to the new genre, and provide fewer tracks from the rock genre.

Although the above procedure has been described using an adaptive classifier for prioritizing a single user session, long-term listening history can also be used to define additional training examples. For example, a per-sample loss weighting that reflects the time passed since that example was collected may be used. For example, a track that was skipped some time back (e.g., a month ago) may be associated with a lower contribution than a track that was skipped more recently (e.g., 10 minutes ago). Another metric may be a fraction of bad watches (e.g., less than k seconds of watch time for a given video), where a previous watch of the video by this user also included less than k seconds of watch time.

Also, for example, a length of the current session may indicate a type of ML model 246 to be used. For example, an initial simple linear classifier may be replaced with a more complex classifier based on a length of the session, and/or an amount of labeled data received. In some embodiments, a neural network may be used to determine the playlist. In some embodiments, the machine learning model is a neural network.

For example, per session behavioral data may be used as label data over a long period of time, and more complicated neural networks like recurrent neural networks (RNNs) and long short-term memory (LSTM) networks may be applied to identify subtleties of a mood of the user and generate more relevant music. In some embodiments, a single session may be associated with a plurality of machine learning models that determine the adaptive playlist, and the models may evolve over time. As illustrated in FIG. 2, ML model 246 may denote a plurality of models. For example, ML model 246 may represent an initial nearest neighbor retrieval model, followed by a simple classifier model that may be subsequently replaced by a more complex classifier (e.g., a complex linear classifier, nonlinear classifier, and so forth). In some embodiments, as a length of a listening session continues beyond a certain time threshold, and/or as a number of user preferences during a current session exceeds a threshold number, ML model 246 may be a more complex neural network (e.g., RNN, LSTM). Generally, a choice of ML model 246 can depend on a number of factors, including for example, on a number and type of user preferences during a current session, a number of changes in broad music categories (e.g., genre, singer, period, language, and so forth), a length of the session, ML models used during previous listening sessions, and so forth.

Some embodiments involve identifying a second listening session different from the listening session. Such embodiments also involve receiving second user preference with a second initial playlist during the second listening session. The training of the machine learning model may be based on the second user preference. The machine learning model may be trained to generate a second updated playlist relevant to an updated listening mood of the user during the second listening session. For example, ML model 246 may be re-initialized during a new listening session to identify a listening mood of the user, and provide an adaptive playlist tailored to a different mood in the new listening session.

In some embodiments, ML model 246 may include a first model that is based on a mood in a current session, and a second background model that is a slow, background model of user overall preference. Tracks that are rejected on the basis of a current listening mood may be weakly fed back into the slower, moodless second background model. Accordingly, if a previously-recommended track is skipped repeatedly by the user, the first model can learn to pass over that track. However, the second model feeds tracks slowly over time, as there may be tracks that the user may skip in a current session with a current mood, but may not skip in a future session with a different mood. In some embodiments, a simple score fusion may be applied between a mix ranker score behind the initial playlist and g_{T} produced within a current session. If the mix ranker score reflects longer term user history, re-sorting may be performed by a combination of the two scores, where the combination weights may depend on T (i.e. the amount of evidence accumulated in the current session).

### Experiments

The adaptive playlisting model may be evaluated using the Resnet-50 audio encoder (M-Resnet-50) and AST audio encoder (M-AST). In both cases a BERT-base-uncased architecture may be used as the text encoder. In some embodiments, models may be trained for 14 epochs on the collection of audio-text pairs mined from the 44M music recordings and the processed text labels in all categories: AudioSet (ASET), short-form tags (SF), long-form sentences (LF), playlist information (PL). An Adam optimizer with weight decay regularization may be used, and with a step decay learning rate schedule using a decay factor 0.9 applied every 40K steps and initial values of 5×10⁻⁵ for M-Resnet-50 and 4×10⁻⁵ for M-AST. The temperature parameter may be initialized to τ=0.1 for all models. M-Resnet-50 may be trained with a batch size of B=6144 pairs, while B=5120 pairs may be used for M-AST (e.g., due to memory limitations). Since M-AST and M-Resnet-50 show roughly similar performance in the evaluation tasks considered, M-Resnet-50 may be used throughout the text ablation study for its better training efficiency.

### Evaluations

The method may be evaluated by pretraining the music-text joint embedding models on the large-scale dataset of (audio, text) pairs and then assess their utility on several types of downstream tasks described in turn below.

i. Zero-Shot Music Tagging

Given a music clip and a set of candidate text label tags, each prediction score may be defined as the cosine similarity between the audio embedding of the music clip and the text embedding of each tag string. The generalization ability of the proposed method to potentially unseen target labels may be achieved through (i) the use of a contextual text encoder, which provides a flexible prediction space, and (ii) the use of cross-modal contrastive learning to anchor the language semantics to an audio representation.

The evaluation may be performed based on two music tagging benchmarks: MagnaTagATune (MTAT) and the music related portion of AudioSet. For MagnaTagATune, a well-exercised top-50 tag set, as well as the full 188 tag set, may be used. Standard train/validation/test partitions may be used (note that zero-shot experiments do not use train/validation). The class-balanced area under the receiver operating characteristic curve (AUC-ROC) on the test set may be obtained. The audio clips in MagnaTagATune are 29 seconds long, so they may be split each into three non-overlapping 10-second segments, and the segment-level embeddings may be averaged to get the clip-level embedding. For AudioSet, a 25-way genre tagging task (Gen-25) may be considered, and a richer 141-way tagging task (Mu-141) that includes the entire music subtree of AudioSet ontology may be considered. In both cases, the larger target tag vocabularies enable measurement of the generalization to a more diverse set of semantic concepts.

Generally, AudioSet is included in contrastive training, and a fraction of MTAT classes overlap with the AudioSet ontology. As a result, AudioSet, and to a lesser extent, MTAT evaluations, may not be strictly zero-shot from a label exposure perspective. However, the explicit, matched AudioSet supervision may be diluted by the abundance of free-form language supervision during playlist generation training. Therefore, by comparing adaptive playlisting models and conventional AudioSet classifiers, the cost of moving to a flexible natural language interface that additionally supports classes outside the AudioSet ontology may be measured.

ii. Transfer Learning with Linear Probes

In addition to the zero-shot experiments introduced above, the audio encoder may be evaluated as a general purpose feature extractor for downstream tagging tasks. Two benchmarks of MagnaTagATune and AudioSet may be used, and the training datasets may be used to train an independent per-class logistic regression layer on top of the frozen 128-dimensional audio embeddings. Use of the same evaluation protocol of past transfer learning studies using these datasets allows for a direct comparison of performance.

iii. Music Retrieval from Text Queries

Given a music search collection and a text query, playlist generation provides the ability to retrieve the music clips that are closest to the query in the embedding space. This evaluation may be relevant to music retrieval applications, where content features can offer finer-grained and more complete similarity information when compared with metadata-based methods. A proprietary collection of 7000 expert-curated playlists may be considered, which do not overlap with the playlist information used in training. Each expert-curated playlist has a title and a description, and consists of 10-100 music recordings. The playlist titles are usually short phrases, including a mixture of genres, sub-genres, moods, activities, artist names, and compositional elements (e.g. “Indie Pop Workout”, “Relaxing Korean Pop”). Playlist descriptions consist of one or more complete sentences (see pos/neg entries of “Playlist” row of Table 3 below for examples). The playlist evaluation can include approximately 100K unique recordings.

Two cross-modal retrieval evaluation sets may be constructed from the expert-curated playlist data, one using titles as queries and the other using descriptions. For each dataset, recordings belonging to the corresponding playlist may be used as the ground truth retrieval targets, and all the 100K recordings as the pool of candidates. Both AUC-ROC and mean average precision (mAP) may be reported. The same embedding averaging and cosine similarity-based scoring mechanism as in the zero-shot tagging case may be used. However, the playlist information is of substantially different nature compared to the tags involved in the music tagging benchmarks. Instead of a small vocabulary of mostly basic genres and instruments, the playlist titles and descriptions have much finer-grained information and are similar to queries that are presented to music search engines.

iv. Text Triplet Classification

Compared to the conventional pre-trained BERT model, the text encoder is fine-tuned using in-domain music data and cross-modal contrastive loss. Generally, there are no text-only training objectives. To measure whether the proposed method deepens the text encoder's understanding of music related text, the text embeddings may be directly evaluated with a triplet classification task. Each triplet consists of three text strings of the form of (anchor, pos, neg), and it is considered correct if pos is closer than neg to anchor in the text embedding space. Two such text triplet evaluation sets may be evaluated. The first uses the AudioSet ontology: for each of the 141 music related classes, the label string may be used as the anchor text, the long-form description may be used as the positive text, and 5 random class's long-form description may be used as the negative text to construct 5 triplets. An example of such triplets is shown in Table 3.

For the second set, 400 triplets may be sampled from the expert-curated playlist data in a similar fashion: a playlist may be sampled, the anchor may be set, and positive text may be taken as the title and description, respectively, and then the negative text may be set to be the description of another randomly sampled playlist. Examples of both sets are shown in Table 3. An example of such a text triplet is shown in Table 3 below.

TABLE 3

| Eval Set | Anchor/Positive/Negative |
|---|---|
| Ontology | Steelpan/Sounds of a tuned percussion instrument |
| | originally constructed from steel oil drums |
| | by hammering out small patches on the head to |
| | produce separate pitches. /The sound of a musical |
| | instrument that produces sound by vibration |
| | of air in a tubular resonator in sympathy with the |
| | vibration of the player's lips. |
| Playlist | Relaxing Korean Pop/Lets make your chill |
| | mood with a collection of easy-going sounds |
| | from Korean artists. /These fun and upbeat |
| | songs from the alternative side of the pop music |
| | spectrum will keep you energized while you |
| | exercise. |

v. Music Tagging

Music tagging results reported in AUC-ROC are illustrated in Table 4 below. Table 4 shows the zero-shot tagging metrics, where M-Resnet-50 and M-AST obtain comparable performance.

TABLE 4

| | |
|---|---|
| AudioSet | MTAT |

| | | | | |
|---|---|---|---|---|
| Model | Gen-25 | Mu-141 | Top-50 | All-188 |

(a) Zero-shot (Trained w/ASET + SF + LF + PL)

| | | | | |
|---|---|---|---|---|
| M-AST | 0.840 | 0.909 | 0.778 | 0.776 |
| M-Resnet-50 | 0.840 | 0.899 | 0.782 | 0.772 |

(b) Text ablation (using M-Resnet-50 Zero-shot)

| | | | | |
|---|---|---|---|---|
| ASET + SF + LF | 0.839 | 0.907 | 0.760 | 0.756 |
| ASET + SF | 0.839 | 0.885 | 0.754 | 0.747 |
| ASET | 0.886 | 0.942 | 0.753 | 0.771 |
| SF/LF Unfiltered | 0.845 | 0.908 | 0.774 | 0.766 |

(c) Linear probe

| | | | | |
|---|---|---|---|---|
| M-AST | 0.906 | 0.942 | 0.925 | 0.953 |
| M-Resnet-50 | 0.910 | 0.940 | 0.927 | 0.954 |
| Baselines: | | | | |
| Hybrid [25] | 0.904 | 0.920 | 0.915 | 0.941 |
| JukeBox [15, 23] | — | — | 0.915* | — |
| MuLaP [32] | — | — | 0.893* | — |
| CLMR [22] | — | — | 0.866* | — |

(d): End-to-end training baselines

| | | | | |
|---|---|---|---|---|
| AST [10] | 0.888 | 0.949 | — | — |
| SC-CNN [42] | — | — | 0.913* | — |

In some embodiments, there may be a significant misalignment between the word sense of a label in the tagging evaluation compared to that in the training text. This may cause a degradation in performance relative to the explicitly supervised linear probe setting where the task-expected tag semantics can be learned. The MTAT gap is substantially larger than AudioSet's, driven by particularly bad performance for (i) MTAT tags with nonspecific meaning or multiple senses, e.g. “weird” and “beats”; and (ii) MTAT tags involving simple negation (e.g. “not rock”, “no piano”). This is likely a result of the text encoder not adequately modeling the meaning of these negated concepts, which is a well-known problem with BERT (e.g., the text embedding of “not rock” is similar to “rock” and performance suffers).

Table 5 below shows the results of the text ablation study, which aims to understand the benefits of different sources of text labels.

TABLE 5

| | |
|---|---|
| Title | Description |

| Model | AUC | mAP | AUC | mAP |
|---|---|---|---|---|
| M-AST | 0.933 | 0.110 | 0.903 | 0.090 |
| M-Resnet-50 | 0.931 | 0.104 | 0.901 | 0.084 |
| Text Ablation: | | | | |
| ASET + SF + LF | 0.917 | 0.101 | 0.892 | 0.077 |
| ASET + SF | 0.913 | 0.089 | 0.867 | 0.060 |
| ASET | 0.626 | 0.005 | 0.688 | 0.009 |
| SF/LF Unfiltered | 0.933 | 0.111 | 0.897 | 0.081 |

In some embodiments, training with AudioSet alone gets the highest AUC in AudioSet evaluation, with the text encoder learning the exact label semantics reflected in the test data. On the other hand, including more data sources in general improves performance on all other downstream tasks (MTAT, retrieval/text triplet evaluations in Tables 5 and 6) and the loss on AudioSet AUC appears to be relatively minor.

For the music tagging tasks considered, training with unfiltered data appears to achieve comparable performance compared to the filtered version. That the model appears to learn similarly useful associations without being overwhelmed by the sheer amount of noise in the raw text data. It is likely that the text filtering used may have been too aggressive, having removed annotations that were not obviously music-related, but semantically important nonetheless. Since contrastive learning is highly noise tolerant, the gain from restricting to more strongly aligned audio-text pairs may have been offset by the loss of a large set of additional useful pairs.

In Table 5, the adaptive playlisting models are evaluated (including with text/filter ablation) on the query retrieval evaluation tasks, where the queries are constructed using expert-curated playlist titles and descriptions. Even though a BERT checkpoint pre-trained with massive language resources is used as a starting point, training the adaptive playlisting model with only AudioSet clips and label annotations provides very limited ability to ground in-domain natural language to music. Such limited cross-modal supervision may not generalize to the rich semantics that appear in the playlist titles and descriptions, which are more in line with the complex queries that are presented to real-world music search engines. Significant gain may be observed after including the large-scale short-form tags mined from the internet, which helps the model learn to ground more fine-grained music concepts. There may be additional gain when including comments and playlist data, where the complete sentences are helpful for grounding the more complex queries, including multi-term queries (e.g. “instrumental action movie soundtrack”), compositional queries (e.g. “classical music with middle eastern influence”), and even queries with negation (e.g. “hard rock without vocals”). Training appears to be robust to annotation noise, achieving similar performance using unfiltered training text.

Text query music retrieval evaluation results are illustrated in Table 6 below. For example, text triplet classification accuracy AudioSet ontology evaluation and Playlist title to description evaluation results are shown. Text ablation/unfiltered models use M-Resnet-50.

TABLE 6

| Model | Playlist | AudioSet |
|---|---|---|
| M-AST | 0.959 | 0.962 |
| M-Resnet-50 | 0.945 | 0.951 |
| Text Ablation: | | |
| ASET + SF + LF | 0.935 | 0.952 |
| ASET + SF | 0.910 | 0.938 |
| ASET | 0.693 | 0.818 |
| SF/LF Unfiltered | 0.949 | 0.959 |
| Baselines: | | |
| SimCSE [45] | 0.950 | 0.938 |
| SBERT [46] | 0.942 | 0.889 |
| USE [47] | 0.918 | 0.946 |
| BERT [38] | 0.850 | 0.847 |

Table 6 shows that when applying linear probes on the adaptive playlisting model audio embeddings, SOTA transfer learning performance may be achieved on tagging tasks. This demonstrates that the adaptive playlisting model's pretrained audio encoder continues to produce high quality general-purpose music audio embeddings, while also supporting new natural language applications. End-to-end training baselines for three of these tasks are shown. The linear probe results exceed 2 of 3, and only slightly trails a SOTA AST AudioSet classifier.

Adaptive playlisting model text embedding may be evaluated against the following baselines: Sentence Transformer, SimCSE, Universal Sentence Embedding, and the average token embedding of BERT-base-uncased. All baselines are Transformer-based models with similar size to the adaptive playlist model described herein. The first three were trained with sentence-level contrastive loss, while BERT is trained with masked language prediction. The adaptive playlisting model text encoder may be warm-started using this same BERT baseline, but it may be subsequently only trained with the cross-modal loss. It appears that when including long-form text annotations, the resulting text embedding model, which is now specialized to the music domain, outperforms the generic sentence embedding models. Thus, successful specialization may be accomplished without using any text-only fine-tuning loss.

### Training Machine Learning Models for Generating Inferences/Predictions

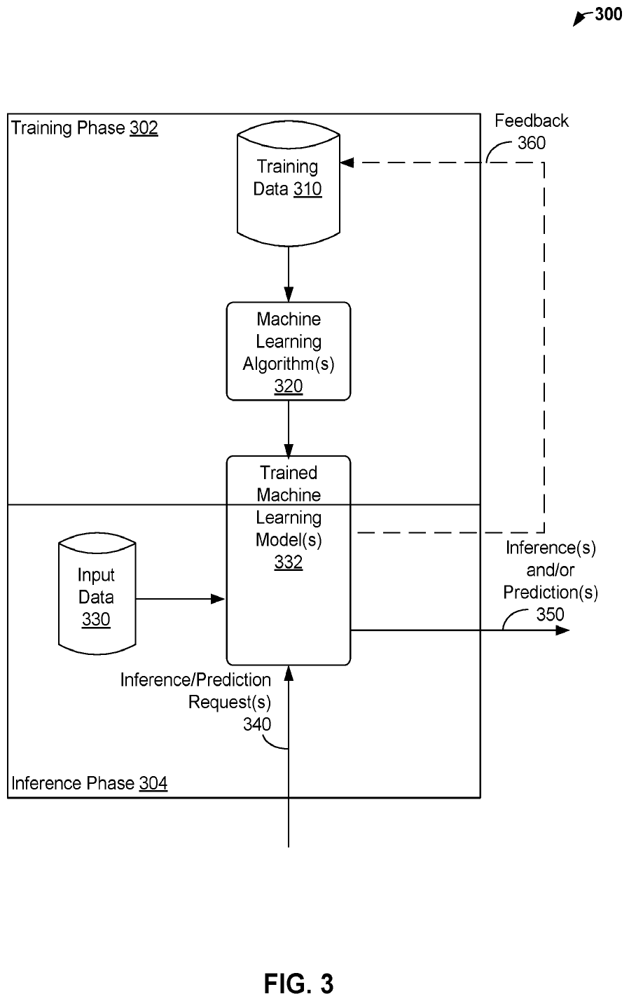

FIG. 3 shows diagram 300 illustrating a training phase 302 and an inference phase 304 of trained machine learning model(s) 332, in accordance with example embodiments. Some machine learning techniques involve training one or more machine learning algorithms, on an input set of training data to recognize patterns in the training data and provide output inferences and/or predictions about (patterns in the) training data. The resulting trained machine learning algorithm can be termed as a trained machine learning model. For example, FIG. 3 shows training phase 302 where one or more machine learning algorithms 320 are being trained on training data 310 to become trained machine learning model(s) 332. Then, during inference phase 304, trained machine learning model(s) 332 can receive input data 330 and one or more inference/prediction requests 340 (perhaps as part of input data 330) and responsively provide as an output one or more inferences and/or prediction(s) 350.

As such, trained machine learning model(s) 332 can include one or more models of one or more machine learning algorithms 320. Machine learning algorithm(s) 320 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 320 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, can reside on, and be executed to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results. Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal overtime. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to computing device CD1, where CD1 is intended to execute the trained machine learning model during inference phase 304. Then, during training phase 302, the pre-trained machine learning model can be additionally trained using training data 310, where training data 310 can be derived from kernel and non-kernel data of computing device CD1. This further training of the machine learning algorithm(s) 320 and/or the pre-trained machine learning model using training data 310 of CD1's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to computing device CD1.

During inference phase 304, trained machine learning model(s) 332 can receive input data 330 and generate and output one or more corresponding inferences and/or prediction(s) 350 about input data 330. As such, input data 330 can be used as an input to trained machine learning model(s) 332 for providing corresponding inference(s) and/or prediction(s) 350 to kernel components and non-kernel components. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from computing device CD1 executing trained machine learning model(s) 332 and/or input data from one or more computing devices other than CD1.

Input data 330 can include training data described herein, such as user preference data with the described interface, including user data from a plurality of users, devices, platforms, inputs, and so forth. Other types of input data are possible as well. For example, training data may include the data collected to train the two-tower joint embedding network.

Inference(s) and/or prediction(s) 350 can include task outputs, numerical values, and/or other output data produced by trained machine learning model(s) 332 operating on input data 330 (and training data 310). In some examples, trained machine learning model(s) 332 can use output inference(s) and/or prediction(s) 350 as input feedback 360. Trained machine learning model(s) 332 can also rely on past inferences as inputs for generating new inferences.

After training, the trained version of the neural network can be an example of trained machine learning model(s) 332. In this approach, an example of the one or more inference/prediction request(s) 340 can be a request to predict an updated playlist relevant to a mood of a user in a current listening session and a corresponding example of inferences and/or prediction(s) 350 can be a predicted updated playlist. Another example of the one or more inference/prediction request(s) 340 can be a request to predict a joint embedding based on a user preference in a current listening session and a corresponding example of inferences and/or prediction(s) 350 can be a predicted joint embedding.

In some examples, one computing device CD_SOLO can include the trained version of the neural network, perhaps after training. Then, computing device CD_SOLO can receive a request to an updated playlist relevant to a mood of a user in a current listening session, and use the trained version of the neural network to predict the updated playlist relevant to a mood of a user in a current listening session.

In some examples, two or more computing devices CD_CLI and CD_SRV can be used to provide output; e.g., a first computing device CD_CLI can generate and send requests to predict an updated playlist relevant to a mood of a user in a current listening session to a second computing device CD_SRV. Then, CD_SRV can use the trained version of the neural network, to predict the updated playlist relevant to a mood of a user in a current listening session, and respond to the requests from CD_CLI. Then, upon reception of responses to the requests, CD_CLI can provide the requested output (e.g., using a user interface and/or a display, a printed copy, an electronic communication, etc.).

### Example Data Network

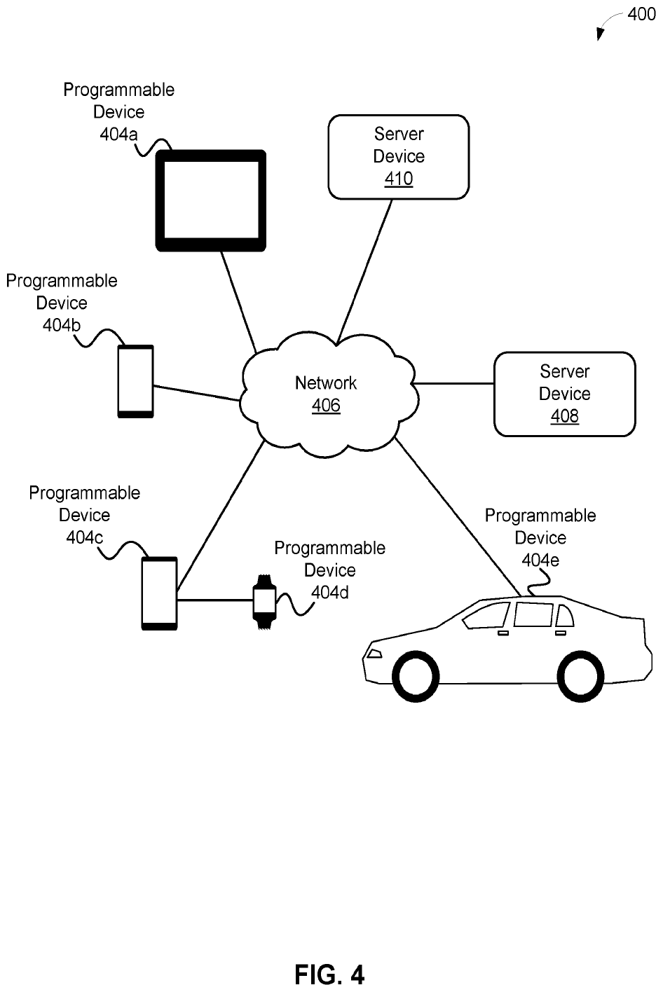

FIG. 4 depicts a distributed computing architecture 400, in accordance with example embodiments. Distributed computing architecture 400 includes server devices 408, 410 that are configured to communicate, via network 406, with programmable devices 404a, 404b, 404c, 404d, 404e. Network 406 may correspond to a local area network (LAN), a wide area network (WAN), a WLAN, a WWAN, a corporate intranet, the public Internet, or any other type of network configured to provide a communications path between networked computing devices. Network 406 may also correspond to a combination of one or more LANs, WANs, corporate intranets, and/or the public Internet.

Although FIG. 4 only shows five programmable devices, distributed application architectures may serve tens, hundreds, or thousands of programmable devices. Moreover, programmable devices 404a, 404b, 404c, 404d, 404e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 404a, 404b, 404c, 404e, programmable devices can be directly connected to network 406. In other examples, such as illustrated by programmable device 404d, programmable devices can be indirectly connected to network 406 via an associated computing device, such as programmable device 404c. In this example, programmable device 404c can act as an associated computing device to pass electronic communications between programmable device 404d and network 406. In other examples, such as illustrated by programmable device 404e, a computing device can be part of and/or inside a vehicle, such as a car, a truck, a bus, a boat or ship, an airplane, etc. In other examples not shown in FIG. 4, a programmable device can be both directly and indirectly connected to network 406.

Server devices 408, 410 can be configured to perform one or more services, as requested by programmable devices 404a-404e. For example, server device 408 and/or 410 can provide content to programmable devices 404a-404e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 408 and/or 410 can provide programmable devices 404a-404e with access to software for database, search, computation, graphical, audio, video, World Wide Web/Internet utilization, and/or other functions. Many other examples of server devices are possible as well.

### Computing Device Architecture

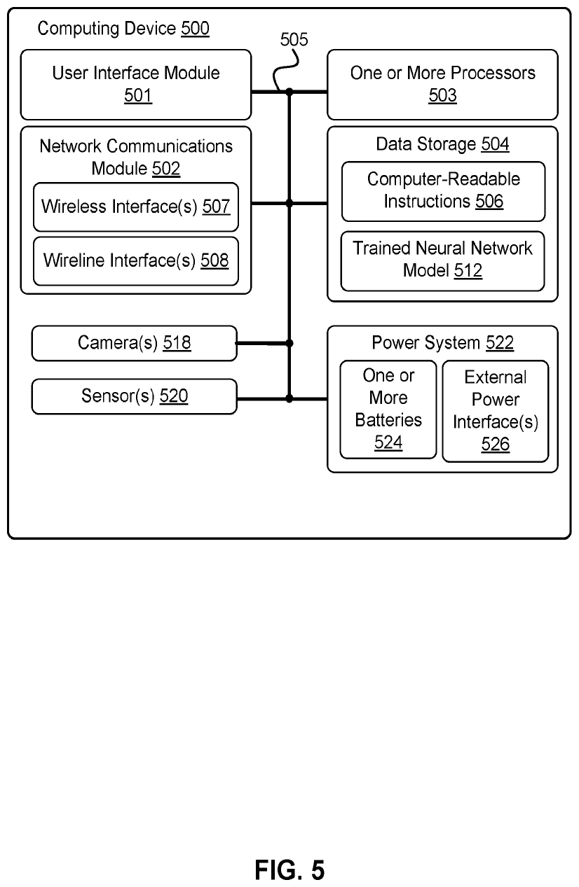

FIG. 5 is a block diagram of an example computing device 500, in accordance with example embodiments. In particular, computing device 500 shown in FIG. 5 can be configured to perform at least one function of and/or related to neural network 100, and/or method 500.

Computing device 500 may include a user interface module 501, a network communications module 502, one or more processors 503, data storage 504, one or more camera(s) 518, one or more sensors 520, and power system 522, all of which may be linked together via a system bus, network, or other connection mechanism 505.

User interface module 501 can be operable to send data to and/or receive data from external user input/output devices. For example, user interface module 501 can be configured to send and/or receive data to and/or from user input devices such as a touch screen, a computer mouse, a keyboard, a keypad, a touch pad, a trackball, a joystick, a voice recognition module, and/or other similar devices. User interface module 501 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 501 can also be configured to generate audible outputs, with devices such as a speaker, speaker jack, audio output port, audio output device, earphones, and/or other similar devices. User interface module 501 can further be configured with one or more haptic devices that can generate haptic outputs, such as vibrations and/or other outputs detectable by touch and/or physical contact with computing device 500. In some examples, user interface module 501 can be used to provide a graphical user interface (GUI) for utilizing computing device 500, such as, for example, a graphical user interface of a mobile phone device.

Network communications module 502 can include one or more devices that provide one or more wireless interface(s) 507 and/or one or more wireline interface(s) 508 that are configurable to communicate via a network. Wireless interface(s) 507 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 508 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 502 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 503 can include one or more general purpose processors, and/or one or more special purpose processors (e.g., digital signal processors, tensor processing units (TPUs), graphics processing units (GPUs), application specific integrated circuits, etc.). One or more processors 503 can be configured to execute computer-readable instructions 506 that are contained in data storage 504 and/or other instructions as described herein.

Data storage 504 can include one or more non-transitory computer-readable storage media that can be read and/or accessed by at least one of one or more processors 503. The one or more computer-readable storage media can include volatile and/or non-volatile storage components, such as optical, magnetic, organic or other memory or disc storage, which can be integrated in whole or in part with at least one of one or more processors 503. In some examples, data storage 504 can be implemented using a single physical device (e.g., one optical, magnetic, organic or other memory or disc storage unit), while in other examples, data storage 504 can be implemented using two or more physical devices.

Data storage 504 can include computer-readable instructions 506 and perhaps additional data. In some examples, data storage 504 can include storage required to perform at least part of the herein-described methods, scenarios, and techniques and/or at least part of the functionality of the herein-described devices and networks. In some examples, data storage 504 can include storage for a trained neural network model 512 (e.g., a model of trained neural networks such as neural network 100). In particular of these examples, computer-readable instructions 506 can include instructions that, when executed by one or more processors 503, enable computing device 500 to provide for some or all of the functionality of trained neural network model 512.

In some examples, computing device 500 can include one or more camera(s) 518. Camera(s) 518 can include one or more image capture devices, such as still and/or video cameras, equipped to capture light and record the captured light in one or more images; that is, camera(s) 518 can generate image(s) of captured light. The one or more images can be one or more still images and/or one or more images utilized in video imagery. Camera(s) 518 can capture light and/or electromagnetic radiation emitted as visible light, infrared radiation, ultraviolet light, and/or as one or more other frequencies of light.

In some examples, computing device 500 can include one or more sensors 520. Sensors 520 can be configured to measure conditions within computing device 500 and/or conditions in an environment of computing device 500 and provide data about these conditions. For example, sensors 520 can include one or more of (i) sensors for obtaining data about computing device 500, such as, but not limited to, a thermometer for measuring a temperature of computing device 500, a battery sensor for measuring power of one or more batteries of power system 522, and/or other sensors measuring conditions of computing device 500; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 500, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 500, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 500, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 520 are possible as well.

Power system 522 can include one or more batteries 524 and/or one or more external power interfaces 526 for providing electrical power to computing device 500. Each battery of the one or more batteries 524 can, when electrically coupled to the computing device 500, act as a source of stored electrical power for computing device 500. One or more batteries 524 of power system 522 can be configured to be portable. Some or all of one or more batteries 524 can be readily removable from computing device 500. In other examples, some or all of one or more batteries 524 can be internal to computing device 500, and so may not be readily removable from computing device 500. Some or all of one or more batteries 524 can be rechargeable. For example, a rechargeable battery can be recharged via a wired connection between the battery and another power supply, such as by one or more power supplies that are external to computing device 500 and connected to computing device 500 via the one or more external power interfaces. In other examples, some or all of one or more batteries 524 can be non-rechargeable batteries.

One or more external power interfaces 526 of power system 522 can include one or more wired-power interfaces, such as a USB cable and/or a power cord, that enable wired electrical power connections to one or more power supplies that are external to computing device 500. One or more external power interfaces 526 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 526, computing device 500 can draw electrical power from the external power source the established electrical power connection. In some examples, power system 522 can include related sensors, such as battery sensors associated with the one or more batteries or other types of electrical power sensors.

### Cloud-Based Servers

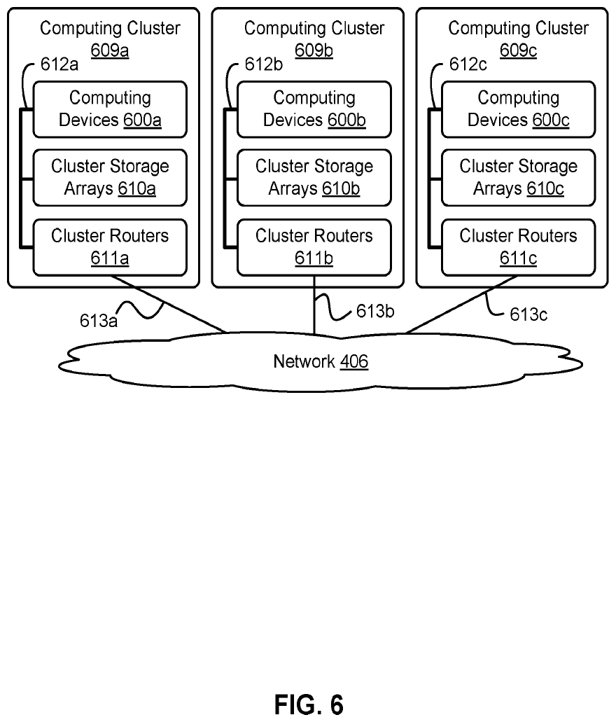

FIG. 6 depicts a cloud-based server system in accordance with an example embodiment. In FIG. 6, functionality of a neural network, and/or a computing device can be distributed among computing clusters 609a, 609b, 609c. Computing cluster 609a can include one or more computing devices 600a, cluster storage arrays 610a, and cluster routers 611a connected by a local cluster network 612a. Similarly, computing cluster 609b can include one or more computing devices 600b, cluster storage arrays 610b, and cluster routers 611b connected by a local cluster network 612b. Likewise, computing cluster 609c can include one or more computing devices 600c, cluster storage arrays 610c, and cluster routers 611c connected by a local cluster network 612c.

In some embodiments, computing clusters 609a, 609b, 609c can be a single computing device residing in a single computing center. In other embodiments, computing clusters 609a, 609b, 609c can include multiple computing devices in a single computing center, or even multiple computing devices located in multiple computing centers located in diverse geographic locations. For example, FIG. 6 depicts each of computing clusters 609a, 609b, 609c residing in different physical locations.

In some embodiments, data and services at computing clusters 609a, 609b, 609c can be encoded as computer readable information stored in non-transitory, tangible computer readable media (or computer readable storage media) and accessible by other computing devices. In some embodiments, computing clusters 609a, 609b, 609c can be stored on a single disk drive or other tangible storage media, or can be implemented on multiple disk drives or other tangible storage media located at one or more diverse geographic locations.

In some embodiments, each of computing clusters 609a, 609b, and 609c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 609a, for example, computing devices 600a can be configured to perform various computing tasks of a conditioned, axial self-attention based neural network, and/or a computing device. In one embodiment, the various functionalities of a neural network, and/or a computing device can be distributed among one or more of computing devices 600a, 600b, 600c. Computing devices 600b and 600c in respective computing clusters 609b and 609c can be configured similarly to computing devices 600a in computing cluster 609a. On the other hand, in some embodiments, computing devices 600a, 600b, and 600c can be configured to perform different functions.

In some embodiments, computing tasks and stored data associated with a neural network, and/or a computing device can be distributed across computing devices 600a, 600b, and 600c based at least in part on the processing requirements of a neural network, and/or a computing device, the processing capabilities of computing devices 600a, 600b, 600c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 610a, 610b, 610c of computing clusters 609a, 609b, 609c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a conditioned, axial self-attention based neural network, and/or a computing device can be distributed across computing devices 600a, 600b, 600c of computing clusters 609a, 609b, 609c, various active portions and/or backup portions of these components can be distributed across cluster storage arrays 610a, 610b, 610c. For example, some cluster storage arrays can be configured to store one portion of the data of a first layer of a neural network, and/or a computing device, while other cluster storage arrays can store other portion(s) of data of second layer of a neural network, and/or a computing device. Also, for example, some cluster storage arrays can be configured to store the data of an encoder of a neural network, while other cluster storage arrays can store the data of a decoder of a neural network. Additionally, some cluster storage arrays can be configured to store backup versions of data stored in other cluster storage arrays.

Cluster routers 611a, 611b, 611c in computing clusters 609a, 609b, 609c can include networking equipment configured to provide internal and external communications for the computing clusters. For example, cluster routers 611a in computing cluster 609a can include one or more internet switching and routing devices configured to provide (i) local area network communications between computing devices 600a and cluster storage arrays 610a via local cluster network 612a, and (ii) wide area network communications between computing cluster 609a and computing clusters 609b and 609c via wide area network link 613a to network 406. Cluster routers 611b and 611c can include network equipment similar to cluster routers 611a, and cluster routers 611b and 611c can perform similar networking functions for computing clusters 609b and 609b that cluster routers 611a perform for computing cluster 609a.

In some embodiments, the configuration of cluster routers 611a, 611b, 611c can be based at least in part on the data communication requirements of the computing devices and cluster storage arrays, the data communications capabilities of the network equipment in cluster routers 611a, 611b, 611c, the latency and throughput of local cluster networks 612a, 612b, 612c, the latency, throughput, and cost of wide area network links 613a, 613b, 613c, and/or other factors that can contribute to the cost, speed, fault-tolerance, resiliency, efficiency and/or other design criteria of the moderation system architecture.

### Example Methods of Operation

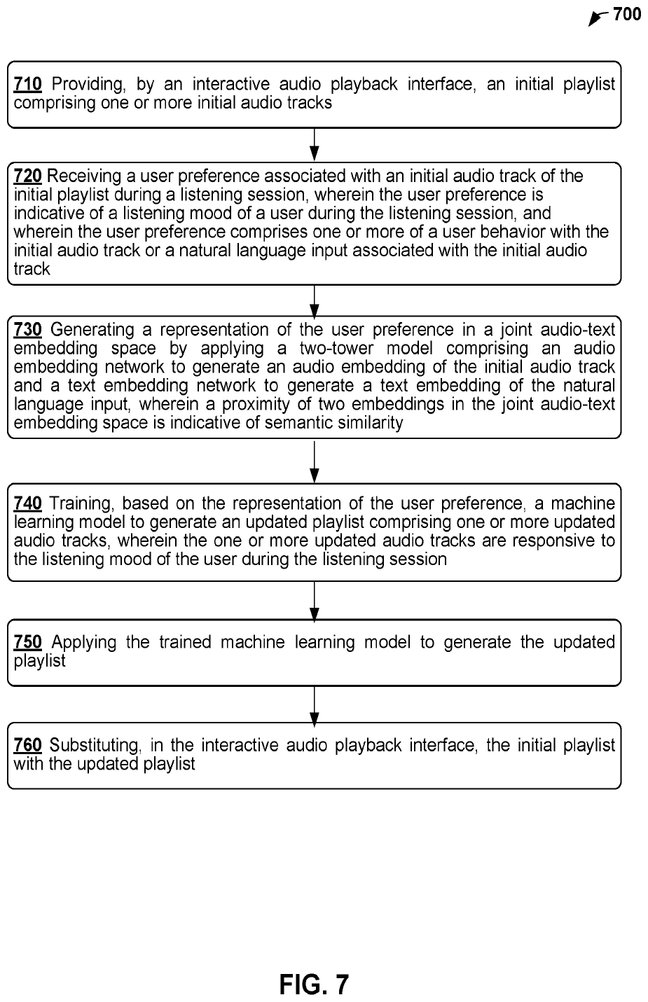

FIG. 7 is a flowchart of a method 700, in accordance with example embodiments. Method 700 can be executed by a computing device, such as computing device 500.

Method 700 can begin at block 710, where the method involves providing, by an interactive audio playback interface, an initial playlist comprising one or more initial audio tracks.

At block 720, the method involves receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track.

At block 730, the method involves generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity.

At block 740, the method involves training, based on the representation of the user preference, a machine learning model to generate an updated playlist comprising one or more updated audio tracks, wherein the one or more updated audio tracks are responsive to the listening mood of the user during the listening session.

At block 750, the method involves applying the trained machine learning model to generate the updated playlist.

At block 760, the method involves substituting, in the interactive audio playback interface, the initial playlist with the updated playlist.

In some embodiments, the user behavior with the initial audio track includes an indication of whether the user listened to, or skipped, the initial audio track. Such embodiments involve assigning a negative label to the initial audio track if it is skipped, or assigning a positive label to the initial audio track if it is listened to.

Some embodiments involve assigning a positive label to the text input.

In some embodiments, the natural language input includes text entered by the user.

In some embodiments, the natural language input is a transcription of a voice input by the user.

In some embodiments, the machine learning model is a linear classifier trained upon receipt of the user preference. In such embodiments, the training of the linear classifier involves training the classifier with loss weighting. In some embodiments, the user behavior with the initial audio track is associated with a relatively smaller loss weight than the text input. In some embodiments, an earlier user preference is associated with a relatively smaller loss weight than a more recent user preference.

In some embodiments, the applying of the trained machine learning model comprises applying the trained machine learning model to one or more of: remaining initial audio tracks in the initial playlist, or a music library. In some embodiments, the music library includes a collection of audio tracks associated with a listening history of the user.

In some embodiments, the applying of the trained machine learning model involves sorting the updated playlist based on relevance of an audio track to the listening mood of the user during the listening session.

Some embodiments involve identifying a second listening session different from the listening session. Such embodiments also involve receiving second user preference with a second initial playlist during the second listening session. The training of the machine learning model may be based on the second user preference. The machine learning model may be trained to generate a second updated playlist relevant to an updated listening mood of the user during the second listening session.

In some embodiments, the machine learning model may be a nearest neighbor retrieval model. Such embodiments also involve applying the nearest neighbor retrieval model in the joint audio-text embedding space to generate the updated playlist comprising one or more audio tracks proximate to the representation of the user preference.

In some embodiments, the machine learning model is a neural network.

Some embodiments involve contrastive training of the audio embedding network and the text embedding network based on audio-text contrastive loss. In such embodiments, the audio-text contrastive loss is a cross-modal extension of an Info Noise-Contrastive Estimation (InfoNCE) loss and a Normalized Temperature-scaled Cross Entropy (NT-Xent) loss.

In some embodiments, the audio embedding network includes a modified Resnet-50 architecture, where a stride of 2 in a first convolutional layer is removed.

In some embodiments, the text embedding network includes a Bidirectional Encoder Transformer (BERT) with base-uncased architecture.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being associated with the following claims.

1. A computer-implemented method, comprising:
providing, by an interactive audio playback interface, an initial playlist comprising one or more initial audio tracks;
receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track;
generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity;
training, based on the representation of the user preference, a machine learning model to generate an updated playlist comprising one or more updated audio tracks, wherein the one or more updated audio tracks are responsive to the listening mood of the user during the listening session;
applying the trained machine learning model to generate the updated playlist; and
substituting, in the interactive audio playback interface, the initial playlist with the updated playlist.

2. The computer-implemented method of claim 1, wherein the user behavior with the initial audio track comprises an indication of whether the user listened to, or skipped, the initial audio track, and the method further comprising:
assigning a negative label to the initial audio track if it is skipped, or assigning a positive label to the initial audio track if it is listened to.

3. The computer-implemented method of claim 1, further comprising:
assigning a positive label to the text input.

4. The computer-implemented method of claim 1, wherein the natural language input comprises text entered by the user.

5. The computer-implemented method of claim 1, wherein the natural language input is a transcription of a voice input by the user.

6. The computer-implemented method of claim 1, wherein the machine learning model is a linear classifier trained upon the receiving of the user preference.

7. The computer-implemented method of claim 6, wherein the training of the linear classifier comprises training the classifier with loss weighting.

8. The computer-implemented method of claim 7, wherein the user behavior with the initial audio track is associated with a relatively smaller loss weight than the text input.

9. The computer-implemented method of claim 7, wherein an earlier user preference is associated with a relatively smaller loss weight than a more recent user preference.

10. The computer-implemented method of claim 1, wherein the applying of the trained machine learning model comprises applying the trained machine learning model to one or more of: remaining initial audio tracks in the initial playlist, or a music library.

11. The computer-implemented method of claim 10, wherein the music library comprises a collection of audio tracks associated with a listening history of the user.

12. The computer-implemented method of claim 1, wherein the applying of the trained machine learning model comprises sorting the updated playlist based on a relevance of an audio track to the listening mood of the user during the listening session.

13. The computer-implemented method of claim 1, further comprising:
identifying a second listening session different from the listening session; and
receiving second user preference with a second initial playlist during the second listening session, and
wherein the training of the machine learning model is based on the second user preference, and wherein the machine learning model is trained to generate a second updated playlist relevant to an updated listening mood of the user during the second listening session.

14. The computer-implemented method of claim 1, wherein the machine learning model is a nearest neighbor retrieval model, and the method further comprising:
applying the nearest neighbor retrieval model in the joint audio-text embedding space to generate the updated playlist comprising one or more audio tracks proximate to the representation of the user preference.

15. The computer-implemented method of claim 1, wherein the machine learning model is a neural network.

16. The computer-implemented method of claim 1, further comprising:
contrastive training of the audio embedding network and the text embedding network based on audio-text contrastive loss.

17. The computer-implemented method of claim 16, wherein the audio-text contrastive loss is a cross-modal extension of an Info Noise-Contrastive Estimation (InfoNCE) loss and a Normalized Temperature-scaled Cross Entropy (NT-Xent) loss.

18. The computer-implemented method of claim 1, wherein the audio embedding network comprises one or more of (i) a modified Resnet-50 architecture, where a stride of 2 in a first convolutional layer is removed, or (ii) an Audio Spectrogram Transformer (AST).

19. The computer-implemented method of claim 1, wherein the text embedding network comprises a Bidirectional Encoder Transformer (BERT) with base-uncased architecture.

20. A computing device, comprising:
one or more processors; and
data storage, wherein the data storage has stored thereon computer-executable instructions that, when executed by the one or more processors, cause the computing device to carry out functions comprising:
providing, by an interactive audio playback interface, an initial playlist comprising one or more initial audio tracks;
receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track;
generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity;
training, based on the representation of the user preference, a machine learning model to generate an updated playlist comprising one or more updated audio tracks, wherein the one or more updated audio tracks are responsive to the listening mood of the user during the listening session;
applying the trained machine learning model to generate the updated playlist; and
substituting, in the interactive audio playback interface, the initial playlist with the updated playlist.

21. An article of manufacture comprising one or more non-transitory computer readable media having computer-readable instructions stored thereon that, when executed by one or more processors of a computing device, cause the computing device to carry out functions comprising:
providing, by an interactive audio playback interface, an initial playlist comprising one or more initial audio tracks;
receiving a user preference associated with an initial audio track of the initial playlist during a listening session, wherein the user preference is indicative of a listening mood of a user during the listening session, and wherein the user preference comprises one or more of a user behavior with the initial audio track or a natural language input associated with the initial audio track;
generating a representation of the user preference in a joint audio-text embedding space by applying a two-tower model comprising an audio embedding network to generate an audio embedding of the initial audio track and a text embedding network to generate a text embedding of the natural language input, wherein a proximity of two embeddings in the joint audio-text embedding space is indicative of semantic similarity;
training, based on the representation of the user preference, a machine learning model to generate an updated playlist comprising one or more updated audio tracks, wherein the one or more updated audio tracks are responsive to the listening mood of the user during the listening session;
applying the trained machine learning model to generate the updated playlist; and
substituting, in the interactive audio playback interface, the initial playlist with the updated playlist.
